(19) United States
(12) Patent Application Publication
(10) Pub. No.: US 2014/0136429 A1
(43) Pub. Date: May 15, 2014

(54) SYSTEMS AND METHODS FOR TRACKING THE USAGE OF ENVIRONMENTALLY EFFICIENT SHIPPING EQUIPMENT AND FOR PROVIDING ENVIRONMENTAL CREDITS BASED ON SUCH USAGE

(71) Applicant: AXIOS MOBILE ASSETS CORP., Vaughan (CA)

(72) Inventors: John Psihos, Vaughan (CA); Richard MacDonald, Vaughan (CA); Matthew Didio, Detroit, MI (US); Marc Topacio, Troy, MI (US)

(21) Appl. No.: 14/081,159

(22) Filed: Nov. 15, 2013

Related U.S. Application Data
(63) Continuation of application No. PCT/CA2012/000482, filed on May 18, 2012.
(60) Provisional application No. 61/487,554, filed on May 18, 2011.

(51) Int. Cl. G06Q 50/28; G06Q 30/00

(52) U.S. Cl. CPC G06Q 50/28; G06Q 30/018
USPC 705/317

(57) ABSTRACT

Various systems and methods for tracking the usage of shipping equipment are disclosed. An environmental benefit associated with the use of the shipping equipment may be determined and corresponding environment credits may be awarded based on the environmental benefit. In some embodiments, the movement and, optionally, the environmental conditions of a shipment or shipping equipment may be tracked as the shipment progresses from an originating location to a destination location. In some embodiments, a shipment or shipping equipment may be tracked by generating a data object that is transported with the shipment. The data object may be updated with the route, environmental conditions and timing of the transportation of the shipment. The data object may be transferred to various devices and locations for transport or storage with the shipment or shipping equipment. Data recorded in the data object may then be used to deliver environmental credits based on the stored data.

This application is a continuation of International Application No. PCT/CA2012/000482 filed May 18, 2012, which claims the benefit of U.S. Provisional Application No. 61/487,554 filed May 18, 2011.

### FIELD

The described embodiments relate to systems and methods for tracking the usage of environmentally efficient shipping equipment and for providing environmental credits based on such usage.

### BACKGROUND

The use and exchange of environmental credits, such as carbon credits, promotes environmentally efficient manufacturing processes, shipping techniques and other desirable activities. In many situations, it is difficult to evaluate the environmental benefit provided by an activity and accordingly difficult to assign a credit for the activity. For example, when a manufacturer reduces package size for a product, this may result in a lower shipping weight, a smaller number of shipments to transport a given number of products. Such a change may allow a more efficient shipment method to be used. Similarly, when a shipper uses a more efficient shipping pallet or a more efficient shipping methodology, it is desirable to quantify the environmental benefit associated with the change and to provide a corresponding credit.

### SUMMARY

A first aspect provides a method for providing environmental credits comprising: providing a piece of shipping equipment; tracking the usage of the shipping equipment during the transportation of goods; determining an environmental benefit based on the usage of the shipping equipment.

In some embodiments, determining the environmental benefit includes a comparison of the transportation of good using the shipping equipment with a corresponding transportation of corresponding goods without use of the shipping equipment.

In some embodiments, determining the environmental benefit includes determining a net environmental benefit per unit distance derived from use of the shipping equipment per a unit distance, determining a total distance for which the shipping equipment has been used and combining the net environmental benefit per unit distance with the total distance.

In some embodiments, the method includes providing a plurality of pieces of shipping equipment and wherein determining the environmental credit includes further combining the number of pieces of shipping equipment with the net environmental benefit per unit distance and the total distance.

In some embodiments, the shipping equipment is a shipping pallet.

In some embodiments, tracking the usage of the shipping equipment includes generating a data object associated with the shipping equipment, transporting the data object in association with transport of the shipping equipment, updating the data object in response to the transport of the shipping equipment and extracting data from the data object.

In some embodiments, the shipping equipment includes a location sensor that allows the location of the shipping equipment to be determined.

In some embodiments, determining the total distance includes tracking the movement of the shipping equipment using the location sensor.

In some embodiments, environmental credits may be awarded based on the use of a piece of second piece of shipping equipment that is shipped together the piece of shipping equipment having a location sensor.

Another aspect provides a shipping system for providing environmental credits, the system comprising: a shipping system server; one or more piece of shipping equipment, wherein at least some pieces of shipping equipment include shipping equipment location sensor; one or more shipping vehicles; a plurality of shipping locations a communication network coupling the shipping system server, shipping equipment location sensor. Information about shipments and environmentally beneficial shipping equipment used for at least some of the shipments is recorded in a database accessible to the shipping system server. Environmental benefits are determined based on the shipment details and the benefit of using the shipping equipment.

In some embodiments, the system includes a plurality of customer interfaces coupled to the shipping system server to allow users of the shipping system to enter and obtain information about shipments.

Additional aspects and embodiments are identified and described below.

### BRIEF DESCRIPTION OF DRAWINGS

Various example embodiments of systems and methods according to the present invention will now be disclosed with reference to the drawings, in which:

FIG. 1 illustrates a first example shipping system;

FIG. 2 illustrates an example piece of shipping equipment of the system of FIG. 1;

FIG. 3 illustrates an example pallet device of the system of FIG. 1;

FIG. 4 illustrates an example vehicle device of the system of FIG. 1;

FIG. 5 illustrates an example location device of the system of FIG. 1;

FIG. 6 illustrates an example shipping system server and several customer interfaces of the system of FIG. 1;

FIG. 7 illustrates an example method of providing environment credits to users of system 100; and

FIG. 8 illustrates portions of another shipping system that utilizes a data object to track shipping equipment.

The Figures are merely examples of various elements of the example embodiments described below and other embodiments may have different configurations and arrangements.

### DESCRIPTION OF EXEMPLARY EMBODIMENTS

Numerous specific details are set forth in order to provide an understanding of the exemplary embodiments described herein. However, it will be understood by those of ordinary skill in the art that the embodiments described herein may be practiced without these specific details. In some instances, well-known methods, procedures and components have not been described in detail so as not to obscure the embodiments described herein. Furthermore, this description is not to be considered as limiting the scope of the embodiments described herein in any way, but rather as merely describing the implementation of several example embodiments.

The embodiments of the systems and methods described herein, and their component nodes, devices and system, may be implemented in hardware or software, or a combination of both. However, preferably, these embodiments are implemented in computer programs executing on programmable computers each comprising at least one processor, a data storage system (including volatile and non-volatile memory and/or storage elements), at least one input device, and at least one output device.

For example and without limitation, the various programmable computers may be a personal computer, laptop, personal data assistant, cellular telephone, smart-phone device, UMPC tablets and wireless hypermedia device or any other data processing or computing device. Program code is executed and applied to data to perform the functions described herein and generate output information. The output information may be provide or applied to one or more output devices, in known fashion.

Each program may be implemented in a high level procedural or object oriented programming and/or scripting language such as Flash or Java, for example, to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by or accessible to a general or special purpose programmable computer, for configuring and operating the computer when the storage media or device is read by the computer to perform the procedures described herein. In various embodiments, the computer program may be stored locally or at a location distant from the computer. In some embodiments, the computer program may be stored on a device accessible through a local area network (LAN) or a wide area network such as the Internet. The subject system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, network based storage and the like. The computer useable instructions may also be in various forms, including compiled and non-compiled code.

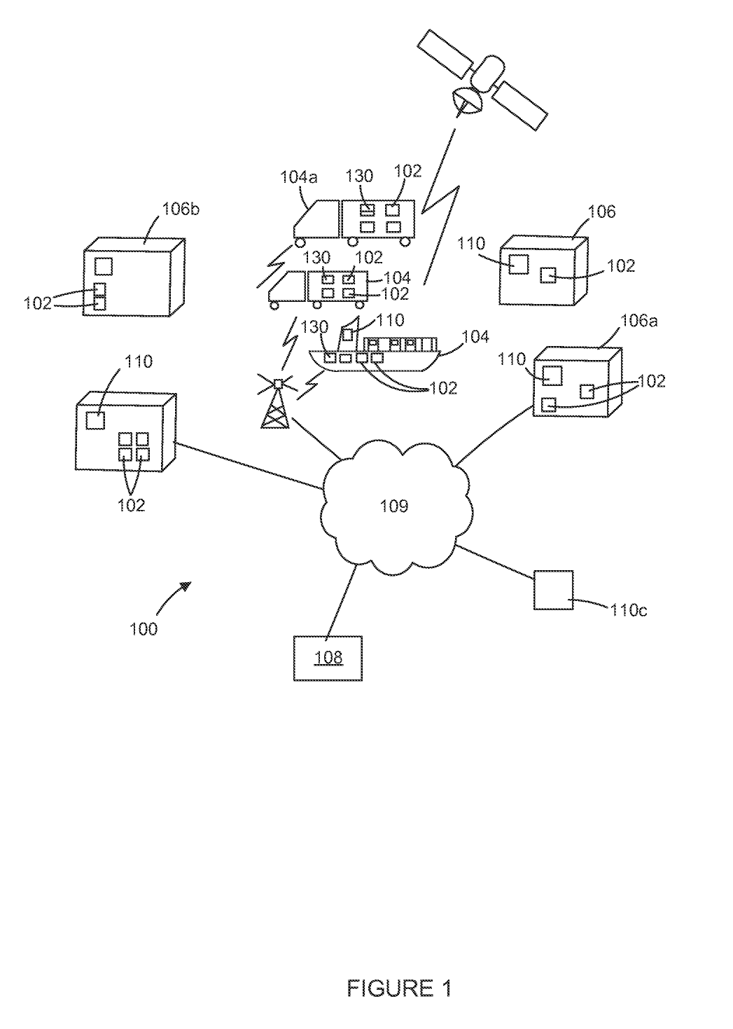

Reference is first made to FIG. 1, which illustrates a shipping system 100. System 100 includes a plurality of shipping pallets 102, a plurality of shipping vehicles 104 and a plurality of shipping locations 106. In addition, system 100 includes a shipping system server 108 and a variety of customer interfaces 110. The shipping server and customer interfaces are coupled through a communication network 109. Some of the customer interfaces are located at some of the shipping locations 106. Some of the customer interface 110 may be located on a shipping vehicle 104. Some customer interfaces, such as customer interface 110c may be accessible to a customer or other user at a computer system coupled to network 109 and need not be at located at a shipping location or on a shipping vehicle. For example, some customer interfaces may be web browser based interfaces that allow a customer to enter data into and access information from the shipping system server 108.

The communication network 109 may include a variety or wired and wireless communication devices, systems and may operate using any number communication protocols. For example, the communication network may include a wide area network such as the Internet, wireless communication systems such as satellite, cellular and Wi-Fi communication device. Each customer interface is able to communicate with the shipping system server 108 through the network 109.

Goods 111 are typically carried on a shipping pallet for shipping from one shipping location to another. Typically, the shipping pallet together with its load of goods is loaded onto a shipping vehicle at a first location. The shipping pallet is transported to a second location where it is unloaded. For example, shipping location 106a may be owned by a user of system 100. The user may wish to ship goods to a shipping location 106b by way a shipping vehicle 104a. The user loads the goods onto one or more pallets 102 and loads the pallets onto one or more shipping vehicles 104 at shipping location 106a. The shipping vehicles 104 then travel to shipping location 106b, where the pallets 102 are offloaded from the shipping vehicles. System 100 allows the location and movements of the pallets 102 to be sensed and tracked. System 100 allows at least some of the environmental benefits of using pallets 102 for transporting to the goods to be quantified and provides environmental credits corresponding to the environmental benefits.

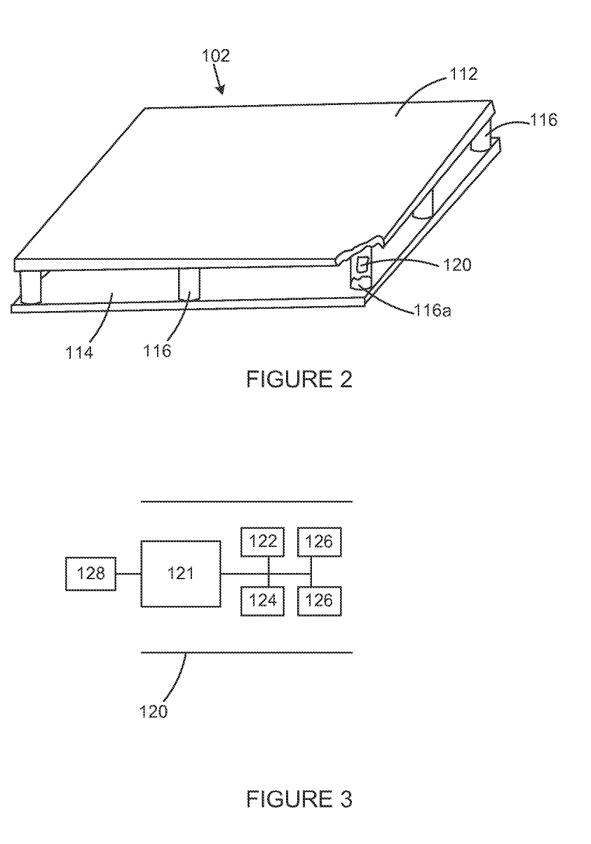

Reference is next made to FIGS. 2 and 3.

FIG. 2 is a partial cutaway view of a pallet 102. Pallet 102 includes a top deck 112, a base 114 and legs 116 connecting the base to the top deck. The legs 116 are hollow and a pallet device 120 is installed within leg 116a.

FIG. 3 illustrates pallet device 120. Pallet device 120 includes a pallet device controller 121, a pallet location sensor 122, an orientation sensor 124 and one or more environmental sensors 126, which may include one or more temperature sensors, shock sensors, pressure sensors, humidity sensors, gyroscopes, gas sensors, stability sensors, orientation detectors and other sensors and detectors.

Pallet location sensor 122 may be any type of location sensing device such as a global positioning system device that receives signals from satellites in earth orbit to determine the location of the pallet location device, and the pallet to which the pallet location device is mounted. In various embodiments, the pallet location sensor 122 may be another location sensing device such as a Wi-Fi location sensing system that uses the location of wireless communications devices based on the IEEE 802.11 standards for implementing wireless local area networks.

Pallet Device 120 also includes a pallet identification device 809, such as a radio frequency identification (RFID) tag or another identification device that allows a particular pallet to be identified. The pallet identification device 128 cooperates with pallet identification sensors installed in system 100 to allow the location of a particular pallet 102 to be determined. In various embodiments, the pallet device may be any type of device that can be detected by a corresponding sensor. For example, pallet identification devices may include transponders, bar codes or other active or passive identification devices.

The pallet location sensor 122, pallet orientation sensor 124, environmental sensors 126 and pallet identification device 128 are all coupled to pallet device controller 121 to allow the pallet device controller to control the operation of or to receive data from the sensors or both. The couplings may be through any type of connection including any type of wired or wireless connection. Data received from the sensors is recorded by the pallet device controller and is contemporaneously or subsequently provided to the shipping system server 108.

Pallet device 120 also includes a pallet device communication module 123, which allows the pallet controller 121 to transmit information to and receive information from shipping system server 108. In various embodiments, pallet device communication module 123 may include one or more communication devices such as a wireless communication module, a wired communication port or module. For example, wireless communication modules may provide communication services according to various protocols including IEEE 802.11 standards, Bluetooth standards, Internet Protocol (IP) transmissions that may be transmitted over a variety of cellular communication systems such as global system for mobile communications (GSM), general packet radio service (GPRS). Various pallet communication devices may communicate with the shipping server 108 through various networks such as a local area network, a proprietary network, a wide area network or a combination of communication channels, links and networks, including network 109.

Pallet 102 is formed of a lightweight material that is lighter than typical pallet materials such as wood, heavier plastics, plastic coated metals and other materials. In this example, pallet 102 is formed of a composite material that is lighter and more easily recycled than typical pallets having a similar load capacity. The use of a lightweight pallet such as pallet 102 provides environmental benefits. Less energy is required to transport the pallet, regardless of the load carried by the pallet. The reduced energy required reduces the fuel required by the shipping vehicle to carry the pallet and its load. Pallet 102 may also have a greater maximum load capacity than standard pallets, allowing a heavier load of goods to be transported on the pallet, potentially reducing the number of pallets required to transport a shipment of goods.

Pallet 102 is an example of a piece of shipping equipment that is used to transport goods. In various systems, other types or pieces of shipping equipment may be used that provide environmental benefits. For example, lightweight shipping containers, environmentally efficient shipping vehicles such as lighter vehicles or vehicles that consume less energy to transport a given load of goods and other types of shipping products may provide environmental benefits. Lighter weight or smaller packaging may be used to package goods and the use of such environmentally friendly packaging may similarly reduce the amount of energy and resources required to transport a given amount of goods. The systems described herein may be adapted to quantify such environmental benefits and to provide environmental credits corresponding to such environmental benefits.

In various embodiments, environmental credits may be provided to one or more entities in response to a reduced environmental impact resulting from a shipment using environmentally friendly shipping equipment. For example, in some situations, environmental credits may accrue to a provider or user of shipping equipment such as a shipping service provider, a company that provides shipping services for its own purposes or for others or both. In other situations, environmental credits may accrue to both a shipping service provider and to a customer of the shipping service provider. For example, the shipping service provider may utilize an environmentally friendly shipping pallet to ship goods and may accrue environmental credits as a result. At the same time, the manufacturer (or shipper) of the goods may package the goods in a manner that reduces the consumption of resources and may also thus accrue environmental credits. In some embodiments, both the environmental benefit accrued by the shipping service provider and by the manufacturer are quantified and each of the shipping service provider and the manufacturer are provided corresponding environmental credits.

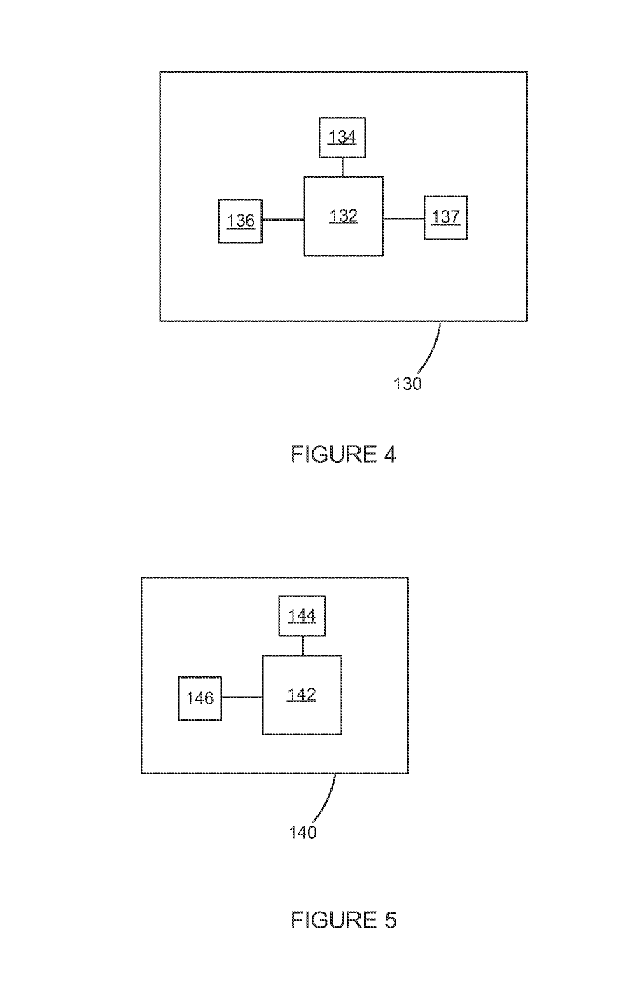

Referring to FIGS. 1 and 4, each shipping vehicle 104 includes one or more vehicle devices 130. Each vehicle device 130 includes a vehicle device controller 132, a vehicle communication module 134, one or more pallet sensors 136 and a vehicle location sensor 137. Pallet sensors 136 and pallet identification devices 128 are complementary devices that selected to operate in a complementary manner to allow the sensors to detect and identify the pallet identification devices 128. For example, if the pallet identification devices are RFID tags, the pallet sensors 136 will be RFID tag sensors. On each shipping vehicle 104, pallet sensors 136 are positioned to allow the presence of a pallet 102 on the shipping vehicle to be sensed.

The vehicle communication module 134 may be a communication module similar to communication module 123 (FIG. 3). The vehicle communication module allows the vehicle device controller 132 to communicate with shipping system server 108 through various communication links, channels and networks, including network 109.

Vehicle location sensor 137 may be any type of location sensing device such as a global positioning system device, a Wi-Fi location sensing system or any other type of location sensing device or system.

Vehicle device controller 132 communicates with each pallet sensor 136 to receive pallet presence data relating to the presence of particular pallets 102 on the vehicle. Some or all of the pallet sensors on a particular vehicle may be installed in various locations on the vehicle to allows pallets in various parts of the vehicle to be sensed. The vehicle device controller may communicate with some or all of the pallets using any wired or wireless communication system. The vehicle device controller 132 records the pallet presence data, or corresponding data, based on the presence of each sensed pallet 102 on the vehicle. The pallet presence data is contemporaneously or subsequently provided to shipping system server 108.

Vehicle device controller 132 also communicates with each vehicle location sensor 137 to obtain vehicle location data corresponding to the location of the shipping vehicle 104 on which the vehicle location is installed. The vehicle location data is recorded by the vehicle device controller 132 for contemporaneous of subsequent transmission to the shipping system server 108.

Referring to FIG. 5, each shipping location includes one or more location devices 140. Each location device 140 that includes a location device controller 142, a communication module 144 and one or more pallet sensors 146. Pallet sensors 146 are selected to operate in a complementary manner to allow the sensors to detect and identify pallet identification devices 128, similar to the pallet sensors 136 of the vehicle devices 130 (FIG. 3). The location device controller 142 communicates with each pallet sensor 146 in its location device using the pallet sensors 136. Some or all of the pallet sensors at a particular location may be installed in various locations at the location to allow pallets in various areas of the location to be sensed. The location device controller may communicate with some or all of the pallets at the location using any wired or wireless communication system. The location device controller 142 records the pallet presence data, or corresponding data, based on the presence of each sensed pallet 102 at the location. The pallet presence data is contemporaneously or subsequently provided to shipping system server 108 using the location communication module 144, which may be similar to communication module 123 (FIG. 3), through various communication links, channels and networks, including network 109. In some embodiments, different parts of a physical location may be treated as different locations. For example, a pallet located in an order assembly area within a physical location may be treated as being in a different location than a pallet located in a shipping dock area of the physical location. In such embodiments, different location devices 140 may be provided for different areas of the physical location or alternatively, a single location device may be provided that is able to sense and distinguish the position of pallets in different areas of the physical location.

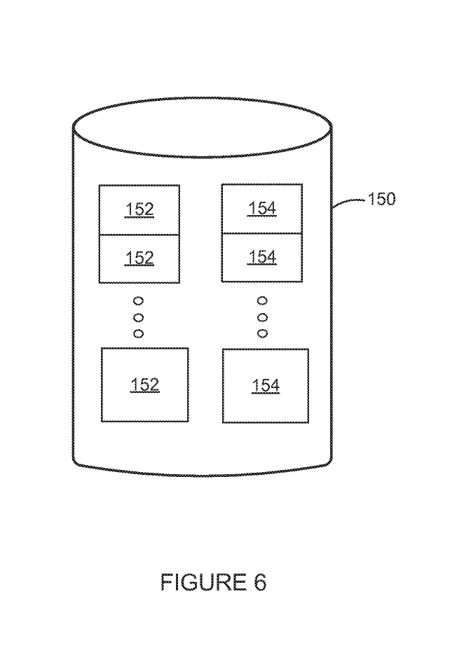

Reference is next made to FIG. 6, which illustrates shipping system server 108 and several customer interfaces 108. Shipping system server 108 includes a system database 150 that is used to store pallet records 152 and shipment records 154.

Each pallet record 152 is used to record information about a pallet 102 in the system 100. Each pallet record includes the following fields:
Pallet Identifier;
Pallet Location;
Pallet Load;
Pallet environmental benefit information;
Pallet Environmental Conditions; and
Pallet Orientation.

Shipment records 154 are used to record information about shipments of goods. A shipment of goods may include one or more loaded pallets. Each shipment record includes the following fields:
Shipment identifier; and
List of pallets in shipment (may include one or more pallets).

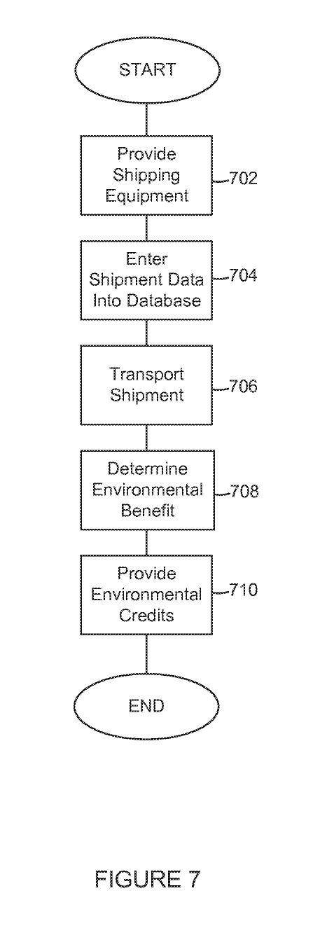

Reference is next made to FIG. 7, which illustrates a method 700 for providing environmental credits to one or more users of system 100.

Method 700 begins in step 702, in which one or more piece of shipping equipment are provided to a shipper. The shipping equipment may be pallets or other environmentally friendly or advantageous products, or a combination of products, that may be used for shipping goods. Method 600 will be explained with reference to shipping pallets, however the method is applicable to other shipping equipment.

Method 700 then proceeds to step 704 in which the shipper prepares a shipment using the shipment equipment. For example, the shipper may load goods onto one or more pallets. The shipper then enters information about the shipment into the database 150. For example, the shipper may enter details of a multi-pallet shipment including the identity of pallets in the shipment. In some embodiments, the shipper may provide additional details of the shipment such as the originating location and destination location for the shipment, details about the goods on each pallet and other details.

A shipper may use a customer interface 110 to enter information about a shipment. In various embodiment, a customer interface 110 may provide shipper or other user of system 100 with a dashboard or portal that allow the user to arrange for shipments to be delivered, provide details about shipments, view details about the user's shipments (such as the location of a shipment, the environmental conditions that the shipment has encountered or is encountering, etc.), proof of delivery, environmental credits. The customer interface 110 may provide a user with various reports, views, alerts and scorecards to allow the customer to learn about and analyze the customer's shipments and usage of system 100.

The originating location of the shipment may be a shipping location 106 that is part of system 100, in which case, the pallet or pallets 102 that form part of the shipment prepared by the shipper will be detected at the shipping location by a location device 140 and corresponding pallet data will be transmitted to the shipping system server 108, which will update the location of the pallet in the corresponding pallet record.

Method 700 then proceeds to step 706 in which the shipment is carried from the originating location to the destination location. During this step, the pallets 102 forming part of the shipment will typically be loaded onto a shipping vehicle 104 at the originating location, transported to another shipping location, where the pallets 102 will be unloaded. In some cases, the pallets may be sequentially loaded onto, transported by and unloaded from a series of shipping vehicles in a series of segments that form the route taken by the shipment from the originating location to the destination location. In some cases, the pallets may be stored at one or more shipping locations between segments of the route.

At each step, the transfer of each pallet 102 in the shipment is tracked. When each pallet 102 is initially loaded onto a shipping vehicle 104 at the originating location, the movement of the pallet 102 is detected in two ways. The removal of the shipping pallet 102 from the originating location is detected by the location device 140 at the originating location. Typically, the location device 140 will determine the removal of the shipping pallet 102 because the location device is unable to detect the presence of the pallet 102 at the shipping location. At the same time, the vehicle device 130 on board the shipping vehicle 104 detects the presence of the shipping pallet 102 on the shipping vehicle. Both the location device 140 and the vehicle device 130 transmit pallet data to the shipping system server 108 indicating the change in the location of the pallet 102 from the originating location to the shipping vehicle.

Similarly, each transition of the shipping pallet 102 from a shipping vehicle 104 to a shipping location 106 or from a shipping location to a shipping vehicle is sensed and identified to the shipping system server 108.

In this way, the movement of each pallet in a shipment is tracked from the originating location to the destination location, through any number of shipping vehicles 104 and intermediate shipping locations 106.

During the transport of the shipping pallet 102 on each shipping vehicle 104 from one shipping location 106 to the next, the distance over which the shipping pallet is transported is tracked. This may be done in a various ways.

In some instances, the movement of the shipping pallet 102 may be tracked using the pallet device 120 in the pallet 102. In this embodiment, each pallet device 102 includes a pallet location sensor 122 (FIG. 3). As pallet 102 is transported, the pallet location sensor 122 may detect the route taken by the shipping vehicle on which the pallet is transported. The details of the route are transmitted by the pallet device 102 to the shipping system server 108.

In some instances, the movement of a shipping pallet 102 may be tracked using the vehicle device 130. In this embodiment, each vehicle device 130 includes a vehicle location sensor 137. As the vehicle is moved from one shipping location 106 to the another, the position of the vehicle is progressively determined by the vehicle location sensor 137. The vehicle device controller 132 obtains the vehicle location from the vehicle location sensor 137 and transmits it to the shipping system server 108. The shipping system server 108 determines the distance travelled by the pallet 102 on the shipping vehicle 104.

In some instances, the movement of a shipment or a piece of shipping equipment may be tracked by tracking the movement of a virtual data object or token. For example, a data object or token may be created or instantiated to represent a shipment or a piece of shipping equipment. The data object or token may be transported in one or more computing devices together with the shipment of shipping equipment and the movement of the computing device or devices may be used to determine the distance travelled by the shipment or shipping equipment. In some situations, the shipping system server may determine the distance travelled by a pallet in a segment between two shipping locations 106 based on the geographic locations of the two shipping locations. For example, routes between two shipping locations 106 may be recorded in the shipping system server 108. The recorded routes may be preferred or mandatory routes chosen by the operator of system 100, by the shipper of the pallet 102 or by another entity associated with the shipment of the pallet 102. Shipping system server 108 may determine the distance of the recorded route. In other instances, the shipping system server 108 may determine a possible route between the two shipping locations 106 using a routing algorithm or routing service. The route chosen will be appropriate for the type of shipping vehicle used for the segment.

Shipping system server 108 determines the distance travelled by the pallet 102 during each segment of its route from the originating location to the destination location using one of the techniques mentioned above or using any other method for determining the distance traveled by a pallet.

Method 700 then proceeds to step 708, in which environmental benefits of transporting goods using the shipping equipment provided in step 602 along the route tracked in step 706 are determined. The shipping system server determines the environmental benefit for each segment in the total route travelled by each pallet 102 in a shipment.

For each shipping pallet 102 in a shipment, and for each segment in the route travelled by that shipping pallet 102, the shipping system server 108 obtains the unit environmental benefit for the type of shipping vehicle used for that segment. The unit environment benefit is combined with the number of units of travel for that segment to determine an environmental benefit for that segment. The environmental benefit for each segment in the total route is combined to determine the total environmental benefit for the transport of the pallet. The total environmental benefit for each pallet 102 in a shipment is combined to determine the total environmental benefit for the entire shipment.

For example, a shipment may consist of three pallets loaded with goods to be transported over a three segment route from an originating location to a destination location. The first segment may be across a body of water such as a lake or ocean in a ship. The second segment may be by highway in a large transport truck. The final segment may be by highway in a smaller delivery vehicle.

For each segment, the shipping system server 108 determines one of the methods described above or any other method for determining or estimating the distance of a segment of a route. The shipping system server 108 also obtains the environmental benefit for each pallet based on the type of shipping vehicle used for that segment. The shipping system server 108 combines the environment benefit which, in this embodiment, is expressed in terms of fuel savings per unit distances (such as miles or kilometers) with the distance travelled for the segment. For example, the shipping may have the following information about a shipment:

| | | | | Total |
|---|---|---|---|---|
| Seg- | Distance | Type of | Environment | environmental |
| ment | Travelled | Vehicle | benefit per mile | benefit |
| 1 | 6000 miles | Container | 0.03 kg CO₂/mile | 540 kg CO₂ |
| | | ship | | |
| 2 | 480 miles | Transport | 0.4 kg CO₂/mile | 576. kg CO₂ |
| | | truck | | |
| 3 | 22 Miles | Delivery | 0.8 kg CO₂/mile | 52.8 kg CO₂ |
| | | truck | | |

| | |
|---|---|
| Total Environment Benefit: | 1168.8 kg CO₂ |

The shipping system server 108 thus determines that the total environmental benefit of using three environmentally friendly pallets 102 for this shipment is the reduction of 1168.8 kg of CO₂.

Method 700 then proceeds to step 710 in which the shipping system server 108 determines an environmental credit corresponding to the total environmental benefit calculated in step 708. In various embodiments, the shipping system server 108 may be configured to determine the number and type of environmental credits according to various systems. In some systems, environmental credits referred to as carbon credits may be earned for reducing CO₂ by 1 tonne or 1000 kg. In such a system, the environmental benefit would be entitled to 1.168 carbon credits. Such carbon credits may be tradable in a marketplace. In other system, environmental benefits may be calculated and converted into environmental credits in a different manner.

Shipping system server 108 then records the earned environmental credit in the shipper's account. Subsequently, the shipper may access the shipper's customer interface 110 to view the total number of earned environmental credits in the shipper's account.

Method 700 then ends.

In system 100, environmental credits are provided to a shipper of a shipment that utilizes or includes a piece of shipping equipment from an originating location and a destination through various route segments and shipping location and on various shipping vehicles. In some embodiments, more than one entity may earn environmental credits. For example, if multiple pieces of shipping equipment are used to transport a shipment, such as an environmentally friendly pallet and environmentally friendly product packaging, then both the shipper that uses the environmentally friendly pallet and the product manufacture or package that uses the environmentally friendly packaging may earn environmental credits.

Environmental credits for any entity for the use of any particular environmental equipment may be calculated by combining the environmental benefit derived from use of that equipment, which may typically be provided based on a unit of usage, such as a unit environmental benefit per distance travelled, and the number of units of distance travelled.

Environmental credits may be calculated in various ways and may be based on a variety of factors. The following are several examples of approaches that may be taken to calculate environmental credits for a shipment.

### Example 1

### Credit Per Unit of Usage

$$EC = F \times {\sum }_{p = 1}^{P} ( D \times {B}_{up} )$$

The environmental credit EC is determined by multiplying an environmental credit conversion factor F by the total environmental benefit for the shipment. The environmental credit conversion factor converts the environmental benefit, which in the example of method 700 above is calculated in kilograms of CO₂, into an environment credit according to a system for providing and exchanging environmental credits. In the example of method 700, the conversion factor would be one carbon credit per 1000 kg CO₂.

The environmental credit is determined for each of P total pieces of shipping equipment in a shipment. For each piece of shipping equipment p, the environmental credit is determined by multiplying the unit environmental credit Bᵤₚ for use of that shipping equipment for a unit of usage by the number of units for which the shipping equipment is used. For example, if the environmental benefit Bᵤₚ resulting from using a pallet is set out based on a unit distance over which the pallet is used, then the environmental credit is product of Bᵤₚ and the distance over which the pallet is used. Some shipping equipment may provide an environmental benefit for the entire time it is used, regardless of whether the shipping equipment is actively being transported or is in storage between segments of route. For example, a shipping container that maintains the temperature of goods in the container in a more environmentally efficient manner than a baseline container may have a unit environmental benefit Bᵤₚ set out in terms of hours of usage. The environmental benefit per unit hour is multiplied by the number of hours the shipping container is used for the shipment to determine the environmental benefit for the use of that piece of shipping equipment.

This example is suitable when the route over which the shipment is transported has a single segment or when the type of shipping vehicle used, and thus the corresponding unit environmental credit is constant for each pallet for each segment of the route.

### Example 2

### Credit Per Unit of Usage for Multi-Segment Route with Varying Environmental Credit Per Segment

$$EC = F \times {\sum }_{s = 1}^{S} {\sum }_{p = 1}^{P} ( {D}_{s} \times {B}_{ups} )$$

In this example, the shipment is transported over a route having S segments. The environmental benefit for each piece of shipping equipment p for each segment s is determined by combining the number of units for which the shipping equipment is used in the segment by the unit environmental benefit Bᵤₚₛ for the shipping equipment for the segment.

### Example 3

### Fixed Benefit for Use of Shipping Equipment

$$EC = F \times ( {\sum }_{s = 1}^{S} {\sum }_{p = 1}^{P 1} ( {D}_{s} \times {B}_{ups} ) + {\sum }_{p = P 1 + 1}^{P} {B}_{f} )$$

In this example, some of the P pieces of shipping equipment provide a unit environmental benefit as they are used. The first P1 pieces of shipping equipment fit into this category. The remaining pieces of shipping equipment (from piece P1+1 to P) provide a fixed benefit each time they are used. For example, some environmentally beneficial shipping equipment may provide more environmentally improved loading or unloading or some other fixed benefit. The environmental benefits for these pieces of shipping equipment is summed together with the environmental benefit accruing from usage of shipping equipment that provides a per unit benefit. The resulting total environmental benefit is converted into a total environmental credit EC.

The unit environmental benefit Bᵤ for a piece of shipping equipment may be determined in many different ways.

For example, the environmental benefit may be determined experimentally. The environmental impact of using a baseline piece of shipping equipment may be determined and then compared to the environmental impact of using an environmentally beneficial piece of shipping equipment. The difference between the two measured environmental impacts may then be set out as a unit environmental benefit for usage of the environmentally beneficial piece of shipping equipment.

As another example, the environmental benefit of using a piece of shipping equipment may be estimated based on the environmental impact of a using a piece of baseline equipment and the difference between the baseline shipping equipment and the environmentally beneficial shipping equipment. For example, if a shipment weighing 5000 lbs (including a 10 baseline shipping pallets) requires 425 gallons of fuel to ship over a distance of 1200 miles, it can be determined that the average fuel consumption is 0.071 gallons/lb/1000 miles. If an environmentally beneficial pallet weights 25 lbs less than the baseline shipping pallet, then fuel consumption may be reduced by 1.77 gallons per 1000 miles. This reduced fuel consumption may be recorded in the shipping database as the unit environmental benefit of using the environmentally beneficial shipping pallets or it may be converted into another unit measure (such as kg CO₂ per mile) and recorded.

A variety of different unit environmental benefits may be recorded for a piece of shipping equipment depending on the particular use of the shipping equipment, such as the shipping vehicle used for a segment, the type or character of the load to be shipped or other factors that may affect the environmental impact of using the shipping equipment.

As noted above, the movement of a shipment of a piece of shipping equipment may be tracked in step 706 of method 700 (FIG. 7) by tracking a virtual object or token, in addition to or instead of the methods described above.

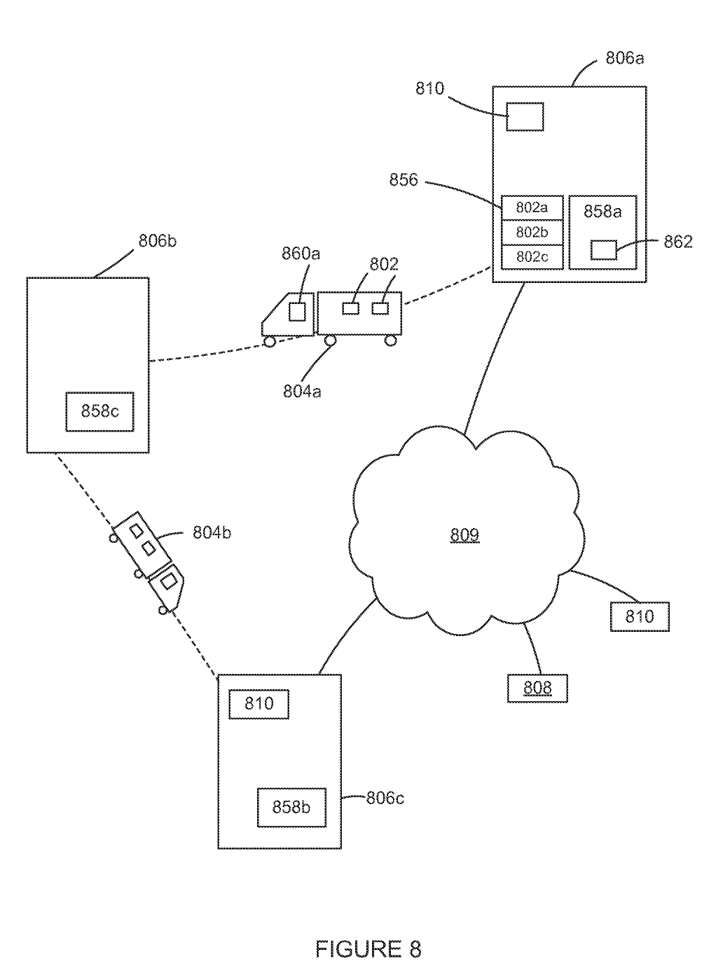

Reference is made to FIG. 8, which illustrates portions of another shipping system 800 in which a data object with near field communication (NFC) tags may be used to track the movement of a shipment, in addition to the devices and methods available in system 100. Elements of system 800 that corresponds to elements of system 100 are identified with similar or corresponding reference numerals.

A data object may contain data and metadata that corresponds to a shipment or a piece of shipping equipment and may include, for example, information about shipping equipment included in a shipment, items in a shipment, the route taken during transport of a shipment, environmental conditions encountered by the shipment during transport, such as temperature, humidity, orientation, physical shock and other conditions, the time at which the shipment reached various points on the route and other such information. A data object may be a relational data object that has an organization or structure that corresponds to structure or order of information recorded in the data object.

A shipment 856 that includes three shipping pallets 802a-c is assembled at a shipping location 806a for shipment to location 806c. Shipping locations 806a include NFC devices 858, some of which may be coupled to shipping system server 808 through a communication network 809. System 800 includes a plurality of NFC tags 860, which may be independent devices or may be integrated into devices such as credit cards, smart cards, communication devices such as smartphones or any other suitable device. NFC devices 858 communicate with a NFC tag to record or store information in the NFC tag and to read or extract information from the NFC tag. In various embodiments, some or all of the NFC tags may be powered or unpowered tags.

A data object 862 identifying the shipment 856 is generated in the shipping system. Typically, the data object 862 will be created in the shipping system using a customer interface 810 and will be associated with pallet records 852 and shipment records 854 corresponding to shipment 856 in database 850.

Shipment 856 is transported from location 806a to location 806c through an intermediate location 806b. Shipment 856 is initially transported from location 806a to location 806b using a first shipping vehicle 804a. The shipment 856 is then transferred to location 806b and subsequently loaded on to shipping vehicle 804b, which is used to transport it to the destination location 806c. Each time the shipment 856 is transferred between a location and a shipping vehicle, the data object 862 is transferred to an NFC tag 860 or other data store that is located or transported with the shipment.

Initially, in conjunction with shipment 856 being assembled at location 806a, data object 862 is created and stored in a data store that is accessible to NFC device 858a. The data store may be a local data storage element at location 806a or it may be part of the shipping system server 808, which is accessible to NFC device 858a through communication network 809.

Initially, when shipment 856 is loaded on to shipping vehicle 804a, data object 862 is recorded in an NFC tag 860a using NFC device 858a. In this example, NFC tag 860a is part of a mobile communication device carried by the driver of a shipping vehicle 804a. Typically, the driver will position his mobile communication device adjacent to NFC device 858a and activate the transfer of the data object 862 to the NFC tag 860a. The driver may do so by identify shipment 856 using a user input device coupled to NFC device 858a or using customer interface 810. The data object is transported by the driver, within his mobile communication device, together with shipment 856 from location 806a to location 806b. When shipment 856 is unloaded at location 804c, the driver of shipping vehicle 804a transfers the data object to NFC device 858c at location 806b by scanning the driver's mobile communication device at NFC device 858c. When the shipment 856 is loaded on to shipping vehicle 806b, the driver of shipping vehicle 806b loads the data object into an NFC tag 860b in the driver's mobile communication device. The data object is subsequently transferred to NFC device 858b when the shipment is delivered to location 806c. In this manner, the data object is transported and stored along with the shipment 856.

At each step of the transportation of shipment 856 from location 806a to location 806c, the data object may be modified to reflect circumstances and events during the transport of the shipment. The NFC tags 860a and 860b may be part of mobile communication devices that have various sensors, including location sensors such as GPS sensors, temperature sensors and other environmental sensors. Data from these sensors may be added to the data object to record the location, environmental conditions and other condition of the transport of shipment 856. The time at which each sensor reading is recorded may also be recorded. In addition, the time at which the data object is transferred to or from an NFC tag may also be recorded in the data object. The data object may thus be updated from the time it is created in association with a shipment at its originating location, while it is transported on various shipping vehicles, through various intermediate locations and ultimately to the destination location. The data recorded in the data object may be used subsequently to review the route and conditions in the shipment was transported and stored.

In practice, a transfer of a data object to or from an NFC tag write or read a copy of the data object, or a data object corresponding to the original data object to or from the NFC tag. Thus the data object is not literally transferred to or from an NFC tag and a copy of the data object may be retained of the transmitting NFC device or NFC tag.

Some or all of the NFC devices 858 may be coupled to shipping system server 808. In this example, NFC device 858b is at a location 806b that is not coupled to shipping system server 808. When a data object associated with a shipment is received at an NFC device coupled to shipping system server 808, the contents of the data object may be transmitted from the NFC device to the shipping system server 808. This allows information recorded in the data object that was not previously available to shipping system server 808 to be recorded in the shipment record 854 or pallet records 852 associated with the shipment. For example, information relating to a shipment that is transported in a region in which communications services are not available may be recorded in a data object recorded in an NFC tag transported with the shipment and then subsequently transferred from an NFC device to the shipping system server. In the example of FIG. 8, when data object 862 is received at location 806c, any data recorded in the data object relating to the time, conditions and route taken by the data object, and thus by the shipment 856, will be transferred to NFC device 858c and may then be transferred to the shipping system server 808. Such data may then be used to determine and provide environment credits.

In various systems, any type of data object that can be transferred between storage devices may be used. Various standards and communication systems may be used to store and transport such data objects with a shipment. For example, any type of radio frequency identification system (RFID), including NFC, Bluetooth™, or other wired or wireless communication technology may be used to transfer information to or from a storage tag or device.

The various environmental and other sensors in a pallet device may provide data that may be used to determine the total environmental benefit to using the pallet or another piece of shipping equipment.

Various embodiments have been described here by way of example only. Various modification and variations may be made to these exemplary embodiments without departing from the spirit and scope of the invention.

1. A method for providing environmental credits comprising:
providing a piece of shipping equipment;
tracking the usage of the shipping equipment during the transportation of goods; and
determining an environmental benefit based on the usage of the shipping equipment.

2. The method of claim 1 wherein determining the environmental benefit includes a comparison of the transportation of good using the shipping equipment with a corresponding transportation of corresponding goods without use of the shipping equipment.

3. The method of claim 1 wherein determining the environmental benefit includes determining a net environmental benefit per unit distance derived from use of the shipping equipment per a unit distance, determining a total distance for which the shipping equipment has been used and combining the net environmental benefit per unit distance with the total distance.

4. The method of claim 1 wherein the method includes providing a plurality of pieces of shipping equipment and wherein determining the environmental credit includes further combining the number of pieces of shipping equipment with the net environmental benefit per unit distance and the total distance.

5. The method of claim 1 wherein the shipping equipment is a shipping pallet.

6. The method of claim 1 wherein tracking the usage of the shipping equipment includes generating a data object associated with the shipping equipment, transporting the data object in association with transport of the shipping equipment, updating the data object in response to the transport of the shipping equipment and extracting data from the data object.

7. The method of claim 1 wherein the shipping equipment includes a location sensor that allows the location of the shipping equipment to be determined.

8. The method of claim 7 wherein determining the total distance includes tracking the movement of the shipping equipment using the location sensor.

9. The method of claim 1 wherein environmental credits may be awarded based on the use of a piece of second piece of shipping equipment that is shipped together the piece of shipping equipment having a location sensor.

10. A shipping system for providing environmental credits, the system comprising: a shipping system server; one or more piece of shipping equipment, wherein at least some pieces of shipping equipment include shipping equipment location sensor; one or more shipping vehicles; a plurality of shipping locations a communication network coupling the shipping system server, shipping equipment location sensor. Information about shipments and environmentally beneficial shipping equipment used for at least some of the shipments is recorded in a database accessible to the shipping system server. Environmental benefits are determined based on the shipment details and the benefit of using the shipping equipment.

11. The system of claim 10 further including a plurality of customer interfaces coupled to the shipping system server to allow users of the shipping system to enter and obtain information about shipments.
